(19) United States
(12) Patent Application Publication
(10) Pub. No.: US 2015/0363794 A1
(43) Pub. Date: Dec. 17, 2015

(54) CONTENT PLACEMENT RECOMMENDATIONS BASED ON PATH ANALYSIS

(71) Applicant: Google Inc., Mountain View, CA (US)

(72) Inventors: Neil Hoyne, Santa Clara, CA (US); Johannes Arensman, San Carlos, CA (US)

(73) Assignee: Google Inc., Mountain View, CA (US)

(21) Appl. No.: 14/230,550

(22) Filed: Mar. 31, 2014

(51) Int. Cl. G06Q 30/02

(52) U.S. Cl. CPC G06Q 30/0201

(57) ABSTRACT

Systems, methods, and computer-readable storage media that may be used to generate content placement recommendations are provided. One method includes determining conversion path data and determining, for each of a plurality of domains: (1) a first metric based on a first set of the conversion paths for which interactions related to the domain are earlier in the conversion paths than one or more last interactions prior to the conversion actions; (2) a second metric based on a second set of the conversion paths for which interactions related to the domain are one of the one or more last interactions prior to the conversion actions; and (3) an analysis metric based on the first metric and the second metric. The method further includes generating one or more recommendations for obtaining content placements in one or more of the domains based on the analysis metrics for the domains.

### BACKGROUND

Content providers often publish content items in networked resources through online content management systems with the goal of having an end user interact with (e.g., click through) the content items and purchase a product or service offered by the content providers. Content providers traditionally have assigned credit for a conversion largely, if not entirely, to the last click prior to the conversion. Attribution is based on the principle that conversion decisions are the cumulative result of many interactions (e.g., clicks, impressions, video views, etc.) over time, and not just the last click prior to a conversion. Evaluating interactions based solely on the last click prior to conversion ignores the contributions made by interactions earlier in the conversion paths.

### SUMMARY

One illustrative implementation of the disclosure relates to a method that includes determining, at a computerized analysis system, conversion path data including data relating to a plurality of conversion paths. Each of the plurality of conversion paths includes one or more interactions leading to a respective one of a plurality of conversion actions. One or more of the plurality of interactions relates to a plurality of domains. The method further includes determining, at the analysis system, for each of the plurality of domains: (1) a first metric based on a first set of the plurality of conversion paths for which interactions related to the domain are earlier in the conversion paths than one or more last interactions prior to the conversion actions of the conversion paths; (2) a second metric based on a second set of the plurality of conversion paths for which interactions related to the domain are one of the one or more last interactions prior to the conversion actions of the conversion paths; and (3) an analysis metric based on the first metric and the second metric indicating a relative position within the plurality of conversion paths of the interactions relating to the domain. The method further includes generating one or more recommendations for obtaining content placements in one or more of the domains based on the analysis metrics for the plurality of domains.

Another implementation relates to a system including at least one computing device operably coupled to at least one memory. The at least one computing device is configured to determine conversion path data including data relating to a plurality of conversion paths. Each of the plurality of conversion paths includes one or more interactions leading to a respective one of a plurality of conversion actions. One or more of the plurality of interactions relates to a plurality of domains. The at least one computing device is further configured to determine, for each of the plurality of domains: (1) a first metric based on a first set of the plurality of conversion paths for which interactions related to the domain are earlier in the conversion paths than one or more last interactions prior to the conversion actions of the conversion paths; (2) a second metric based on a second set of the plurality of conversion paths for which interactions related to the domain are one of the one or more last interactions prior to the conversion actions of the conversion paths; and (3) an analysis metric based on the first metric and the second metric indicating a relative position within the plurality of conversion paths of the interactions relating to the domain. The at least one computing device is further configured to generate one or more recommendations for obtaining content placements in one or more of the domains based on the analysis metrics for the plurality of domains.

Yet another implementation relates to one or more computer-readable storage media having instructions stored thereon that, when executed by at least one processor, cause the at least one processor to perform operations. The operations include determining conversion path data including data relating to a plurality of conversion paths. Each of the plurality of conversion paths includes one or more interactions leading to a respective one of a plurality of conversion actions. One or more of the plurality of interactions relates to a plurality of domains. The operations further include determining, for each of the plurality of domains: (1) a first metric based on a first set of the plurality of conversion paths for which interactions related to the domain are earlier in the conversion paths than one or more last interactions prior to the conversion actions of the conversion paths; (2) a second metric based on a second set of the plurality of conversion paths for which interactions related to the domain are one of the one or more last interactions prior to the conversion actions of the conversion paths; and (3) an analysis metric based on the first metric and the second metric indicating a relative position within the plurality of conversion paths of the interactions relating to the domain. The operations further include receiving input from a content provider representing a desired strategy for generating one or more recommendations. The desired strategy relates to a desired position of the interactions to which the domain relates within the plurality of conversion paths. The operations further include generating the one or more recommendations for obtaining content placements in one or more of the domains based on the analysis metrics for the plurality of domains and the input representing the desired strategy.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a flow diagram of a process for generating content placement recommendations based on analysis of conversion path data according to an illustrative implementation.

FIG. 3 is a flow diagram of a process for determining an analysis metric for a domain based on an aggregation of conversion path data associated with multiple content providers according to an illustrative implementation.

FIG. 4 is a visual representation of conversion path data according to an illustrative implementation.

FIG. 5 is an illustration of a user interface configured to provide content placement recommendations such as those generated using the process of FIG. 2 according to an illustrative implementation.

FIG. 6 is a flow diagram of a process for generating recommendations based on current content placements of a content provider according to an illustrative implementation.

FIG. 7 is a flow diagram of a process for determining whether to recommend changes to obtained content placements according to an illustrative implementation.

FIG. 8 is a block diagram of a computing system according to an illustrative implementation.

### DETAILED DESCRIPTION

Referring generally to the Figures, various illustrative systems and methods are provided that may be used to generate recommendations for obtaining content placements in one or more domains. Content providers often focus heavily, if not exclusively, on the last interactions (e.g., last clicks) prior to a converting activity, such as a purchase or receipt of requested information from a user. However, interactions occurring earlier in series of interactions with the user leading to a converting activity may contribute significantly to the ultimate conversion. In some circumstances, a content provider may place significant emphasis on display content items and/or affiliate content items in domains associated with lower-funnel interactions (e.g., interactions that occur near converting actions, such as a user purchasing a product or providing requested information to the content provider), but may miss early opportunities to introduce a product/service and/or brand to a consumer.

This disclosure provides systems and methods for analyzing conversion path data and generating recommendations for content placement opportunities based on the analysis. An illustrative analysis system may determine conversion path data including data relating to a plurality of conversion paths. Each conversion path includes one or more user interactions leading to a converting action, such as interactions with a resource (e.g., a webpage), a paid or unpaid content item displayed within a resource, a paid or unpaid content item associated with a search engine interface, and interaction with an affiliate resource of a content provider, etc.

The analysis system may determine an analysis metric for each of the domains. In some implementations, the analysis metric may be an assist-to-last ratio for the domain. An assist-to-last ratio may be defined as a measure of a number of assisting user interactions associated with the domain (e.g., user interactions earlier than one or more last user interactions prior to a conversion action within the conversion paths) versus a number of last user interactions (e.g., one or more user interactions immediately preceding a conversion event within the conversion paths). In some implementations, the analysis system may aggregate the analysis metric for a domain across conversion path data for a plurality of content providers. In some such implementations, an individual analysis metric may be calculated for each content provider, and the individual analysis metrics may be aggregated (e.g., averaged) to determine the analysis metric for the domain. In some implementations, the user interactions and/or conversion paths upon which the analysis metric is calculated may be determined based on predefined rules, such as a payment basis of paid content placements associated with the interactions (e.g., whether the content placements were paid on an impression basis or click basis) and/or a characteristic of an origin resource associated with the interactions (e.g., whether the origin resource is a known resource, such as a known search engine, to the analysis system).

The analysis system may generate one or more recommendations for obtaining content placements in one or more of the domains based on the analysis metrics. In some implementations, the recommendations may be provided based on part on grouping domains using characteristics, such as an industry category associated with the domains or predicted cost of the placements in the domains. In some such implementations, the analysis system may only provide recommendations in a particular predicted cost range or in a particular industry category, or may provide multiple recommendations across different cost ranges/industry categories.

In some implementations, the analysis system may generate the recommendations based in part on an analysis metric associated with a content provider's content placements. The analysis system may determine an analysis metric for the content provider and compare the analysis metric to analysis metrics for the domains, and may generate the recommendations based on the comparison. In some such implementations, the analysis system may recommend obtaining content placements in domains having analysis metrics that are similar to the analysis metric of the content provider. In some such implementations, the analysis system may recommend obtaining content placements in domains having analysis metrics that are associated with more upper-funnel interactions (e.g., earlier in the chain of user interactions, far before the conversion actions) than the user interaction position represented by the analysis metric of the content provider.

In some implementations, the analysis system may determine the recommendations based in part on a desired strategy of the content provider. In some such implementations, the content provider may provide input indicating that the content provider wishes to pursue content placement opportunities that are more upper-funnel than its current placements. In some implementations, the content provider may indicate an aggressiveness level for the placements. For instance, the content provider may wish to pursue less aggressive upper-funnel placements (e.g., placements that are in a position slightly further up the funnel from the content provider's current placements) or more aggressive upper-funnel placements (e.g., placements that are near the beginning of the conversion paths). In some implementations, the analysis system may monitor implemented recommendations to determine whether they are meeting the desired strategy of the content provider and, if not, may recommend changes to the placements to meet the desired strategy.

In some implementations, a content network may utilize the analysis metrics to determine whether to invite one or more domain providers to add their domains to the content network. The content network may offer content placements across domains to be purchased by content providers (e.g., through a bidding process). The content network may utilize the analysis metrics to determine how closely the domains are associated with conversion actions within the conversion path data. In some implementations, the analysis system may recommend inviting and/or provide invitations for one or more domains that frequently appear in conjunction with upper-funnel user interactions within the conversion path data, which may indicate that the domains provide a good early opportunity for product and/or brand exposure that may help lead to later conversions.

In some implementations, the analysis metrics may be used to compare the content network to one or more competitor content networks. In some such implementations, a first analysis metric may be determined for placements offered by the content network, and a second analysis metric may be determined for placements offered by a competitor network. The analysis metrics may be compared to provide an indication of the relative position of the user interactions associated with the content placements offered by the networks within the conversion paths.

For situations in which the systems discussed herein collect and/or utilize personal information about users, or may make use of personal information, the users may be provided with an opportunity to control whether programs or features may collect personal information (e.g., information about a user's social network, social actions or activities, a user's preferences, a user's current location, etc.), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server. Further, the individual user information itself is not surfaced to the content provider, so the content provider cannot discern the interactions associated with particular users.

For situations in which the systems discussed herein collect and/or utilize information pertaining to one or more particular content providers, the content providers may be provided with an opportunity to choose whether to participate or not participate in the program/features collecting and/or utilizing the information. In some implementations, the information may be anonymized in one or more ways before it is utilized, such that the identity of the content provider with which it is associated cannot be discerned from the anonymized information. Additionally, data from multiple content providers may be aggregated, and data presented to a content provider may be based on the aggregated data, rather than on individualized data. In some implementations, the system may include one or more filtering conditions to ensure that the aggregated data includes enough data samples from enough content providers to prevent against any individualized content provider data being obtained from the aggregated data. The system does not present individualized data for a content provider to any other content provider.

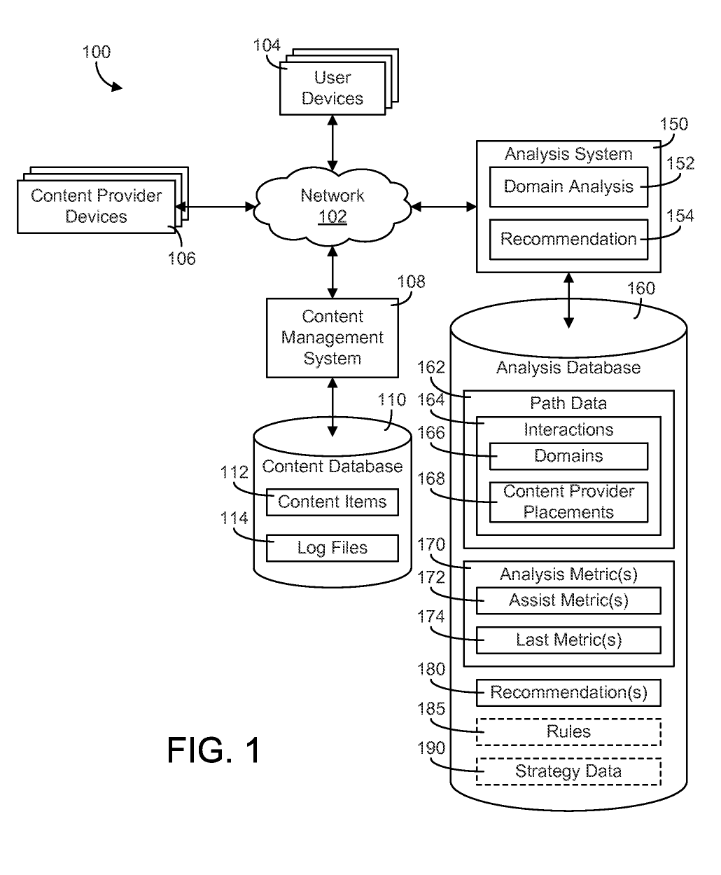

Referring now to FIG. 1, and in brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids.

An analysis system 150 may be configured to analyze path data relating to interactions of one or more users of user devices 104 and generate recommendations (e.g., to be presented to a content provider) for obtaining content placements. In some implementations, analysis system 150 may receive path data 162 that includes multiple paths. Each path represents one or more interactions 164 of a user with one or more resources (e.g., webpages, applications, etc.) and/or content items (e.g., paid and/or unpaid content items displayed within a resource, such as items displayed within a search engine results interface). System 150 may identify one or more conversion paths from among path data 162, each of which may conclude with a converting action, such as a purchase of an item by a user (e.g., a product and/or service offered by a content provider), receipt of requested information from a user, and/or another type of action performed by the user that is desirable to a content provider. Each conversion path may include one or more interactions with a user leading to the converting action, and one or more of the interactions may be associated with one or more domains (e.g., web domains, such as a domain under which one or more webpages is published). For each domain, system 150 may determine an analysis metric indicating a relative position within the conversion paths of the interactions relating to the domain. System 150 may utilize the analysis metric to generate one or more recommendations for obtaining content placements in one or more of the domains. In one illustrative implementation, system 150 may recommend that a content provider obtain content placements in a particular domain if the analysis metric for the domain indicates that the domain appears frequently in connection with early interactions within the conversion paths, indicating that the domain may help increase awareness of a content provider's brand.

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may comprise a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other illustrative parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of a particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device or to enter a bid amount for another type of device as part of the same campaign. For example, content management system 108 may suggest that a third-party content provider increase or decrease their bid amount for desktop devices by a certain percentage, to create a bid amount for mobile devices.

Analysis system 150 may be configured to analyze path data 162 relating to user interactions with one or more items, such as resources (e.g., webpages, applications, etc.) and/or paid or unpaid content items displayed within an interface in a resource (e.g., a content interface displayed within a webpage), and generate one or more recommendations 180 for obtaining content placements in one or more domains 166. Analysis system 150 may include one or more processors (e.g., any general purpose or special purpose processor), and may include and/or be operably coupled to one or more memories (e.g., any computer-readable storage media, such as a magnetic storage, optical storage, flash storage, RAM, etc.). In various implementations, analysis system 150 and content management system 108 may be implemented as separate systems or integrated within a single system (e.g., content management system 108 may be configured to incorporate some or all of the functions/capabilities of analysis system 150).

Analysis system 150 may include one or more modules (e.g., implemented as computer-readable instructions executable by a processor) configured to perform various functions of analysis system 150. Analysis system 150 may include a domain analysis module 152 configured to analyze path data 162 and determine one or more analysis metrics 170 relating to one or more domains 166. Path data 162 may include a plurality of conversion paths including one or more interactions 164 leading to a conversion event, such as a purchase of an item. One or more of interactions 164 may relate to one or more domains 166 (e.g., web domains). In some illustrative implementations, one or more interactions 164 may include user interactions with paid and/or unpaid content posted on webpages published under a particular domain 166.

Domain analysis module 152 may be configured to analyze the conversion paths in path data 162 and determine an analysis metric 170 for one or more domains 166 indicating a relative position within the conversion paths of the interactions relating to each domain. In some implementations, domain analysis module 152 may determine a first assist metric 172 for each domain based on a first set of the conversion paths for which the interactions relating to the domain appear earlier within the paths than one or more last interactions prior to the conversion actions. In some implementations, domain analysis module 152 may determine another metric, a last metric 174, for each domain based on a second set of the conversion paths for which the interactions relating to the domain are one of the one or more last interactions prior to the conversion actions. In some implementations, domain analysis module 152 may determine analysis metric 170 for each domain based on assist metric 172 and last metric 174 for the domain.

In some implementations, analysis system 150 may include a recommendation module 154 configured to generate one or more recommendations 180 for obtaining content placements in one or more of domains 166 based on analysis metrics 170. In some implementations, recommendation module 154 may generate recommendations 180 based on the information analysis metrics 170 provide about the relative position of domains 166 within the conversion paths reflected in path data 162. In some illustrative implementations, recommendation module 154 may generate a recommendation that a content provider consider obtaining content placements in a particular domain because the analysis metric for the domain indicates that the domain appears frequently earlier in conversion paths than the last interaction(s). This may indicate that the domain may provide a good opportunity for the content provider to increase exposure of its brands earlier in users' consideration process, potentially before users begin focusing on other brands. In some illustrative implementations, recommendation module 154 may additionally or alternatively generate a recommendation that a content provider consider obtaining content placements in a particular domain because the analysis metric for the domain indicates that the domain appears frequently later in the conversion paths (e.g., is frequently a last interaction or one or the last interactions before conversion). This may indicate that placements in the domain may be likely to directly drive additional conversions. In some implementations, recommendation module 154 may generate recommendations 180 based in part on an analysis metric associated with current content placements of the content provider and/or based on a desired strategy of the content provider (e.g., whether the content provider wants to see recommendations for placements near the position of its current placements in the conversion paths, earlier in the conversion paths, later in the conversion paths, etc.).

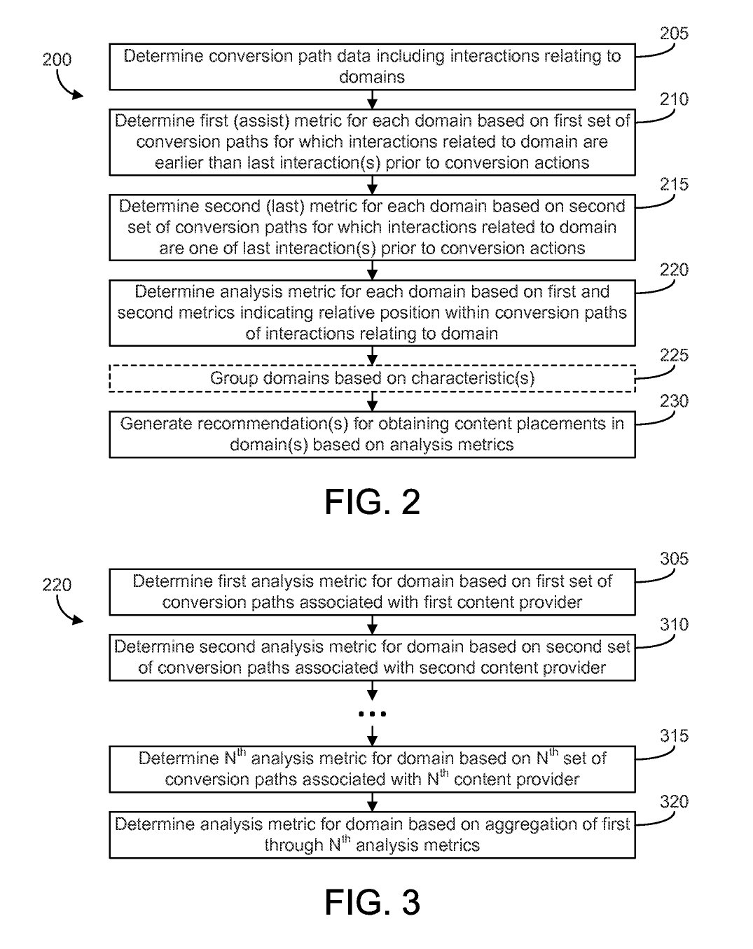

FIG. 2 illustrates a flow diagram of a process 200 for generating content placement recommendations based on analysis of conversion path data according to an illustrative implementation. Referring to both FIGS. 1 and 2, analysis system 150 may be configured to determine (e.g., receive) conversion paths within path data 162 including interactions 164 relating to one or more domains 166 (205). In various implementations, some of the interactions may relate to resources (e.g., webpages, applications, etc.) associated with one or more domains and/or content items provided within resources (e.g., within a content interface). The content items may include paid content items (e.g., paid items displayed within a search engine results interface and/or a different webpage, such as through the use of an auction process) and/or unpaid content items (e.g., unpaid search results displayed within a search engine results interface, unpaid links within a webpage, etc.). A content campaign may include one or more content items that the content provider wishes to have presented to user devices 104 by content management system 108. In some implementations, some of the content items may have one or more products and/or services associated with the content item. In some implementations, such content item may be designed to promote one or more particular products and/or services. In some implementations, some content items may be configured to promote a content provider, an affiliate of the content provider, a resource (e.g., website) of the content provider, etc. in general, and the products and/or services associated with the content item may be any products and/or services offered for sale through the content provider, affiliate, resource, etc.

Path data 162 may include any type of data from which information about previous interactions of a user with resources and/or content items can be determined. The interactions may be instances where impressions of a content item have been displayed on the user device of the user, instances where the user clicked through or otherwise selected the content item, instances where the user converted (e.g., purchased a product/service as a direct or indirect result of an interaction with a campaign content item), etc.

In some implementations, path data 162 may include resource visitation data collected by analysis system 150 describing some or all activities leading to a website or other resource, such as a resource through which a conversion action (e.g., purchase) is performed. Analysis system 150 may collect information relating to a portion of the resource visited/accessed, an identifier associated with the user device that accessed the resource, information relating to an origin or previous location that the user/device last visited before accessing the resource, information relating to a trigger that caused the user device (e.g., device browser application) to navigate to the resource (e.g., the user manually accessing the resource, such as by typing a URL in an address bar, a link associated with a content item selected on the user device causing the user device to navigate to the resource, etc.), and/or other information relating to the user interaction with the resource. In some implementations, path data 162 may include one or more keywords associated with content items through which the resource was accessed.

In some implementations, path data 162 may include result data associated with a resource visit or other user interaction with one or more content items of the content campaign. The result data may indicate whether the visit resulted in the purchase of one or more products or services, an identity of any products/services purchased, a value of any purchased products/services, etc. In some implementations, path data 162 may be configured to follow a path from a first user visit to the resource and/or interaction with a content item of the content campaign to one or more conversions resulting from visits/interactions. The full path from a first user interaction to a converting action, such as a purchase or provision of information requested by a content provider, may be referred to as a converting path. In some implementations, path data 162 may include data relating to multiple conversion paths.

In various implementations, path data 162 may reflect one or more of a variety of different types of user interactions. In some illustrative implementations, the interactions may include viewing a content item impression, clicking on or otherwise selecting a content item impression, viewing a video, listening to an audio sample, viewing a webpage or other resource, and/or any other type of engagement with a resource and/or content item displayed thereon. In some implementations, the interactions may include any sort of user interaction with content without regard to whether the interaction results in a visit to a resource, such as a webpage.

In various implementations, an identifier may be a browser cookie, a unique device identifier (e.g., a serial number), a device fingerprint (e.g., collection of non-private characteristics of the user device), or another type of identifier. The identifier may not include personally identifiable data from which an actual identity of the user can be discerned. Analysis system 150 may be configured to require consent from the user to tie an identifier to path data 162. In some implementations, path data from multiple sources may be utilized even if the path data sets reference different types of identifiers. For example, paths may be joined by matching one identifier (e.g., browser cookie) with another identifier (e.g., a device identifier) to associate both path data sets as corresponding to a single user.

Path data 162 may include conversion paths having one or more interactions 164 associated with one or more domains 166. In some implementations, one or more of the interactions may be with paid content items displayed within resources of one or more of domains 166 by one or more content networks configured to determine content items to display within content items of the resources (e.g., using auction processes). In some implementations, one or more of the interactions may be with paid content items displayed within resources of affiliate domains with which a content provider has an agreement for the affiliate domain to display content items of the content provider within one or more resources of the affiliate domain. In some implementations, one or more of the interactions may be with unpaid content items displayed within resources of one or more of domains 166 (e.g., unpaid links).

Analysis system 150 may determine a first assist metric 172 for each of one or more of the domains 166 based on a first set of conversion paths within path data 162 for which interactions relating to the domain are earlier than one or more last interactions prior to the conversion actions (210). Assist metric 172 may be indicative of an absolute amount or relative amount (e.g., ratio/percentage) of interactions and/or conversion paths associated with the domain for which the interactions related to the domain serve an assisting role (e.g., occur prior to the last interaction(s) in the conversion paths and assist in generating user interest leading to the conversions). In some implementations, assist metric 172 may be an amount of interactions related to the domain that occur prior to the last interaction(s) (e.g., such that assist metric 172 reflects each instance of an assisting interaction related to the domain, including multiple assisting interactions occurring within the same conversion path). In some implementations, assist metric 172 may be an amount of conversion paths including an interaction related to the domain that occurs prior to the last interaction(s) in the conversion path (e.g., such that assist metric 172 counts each path including an assisting interaction only once, regardless of how many assisting interactions related to the domain are included within a conversion path). In some implementations, assist metric 172 may be an amount of interactions and/or conversion paths for which interactions related to the domain are earlier than the last interaction immediately preceding the conversion action within a respective conversion path. In some implementations, assist metric 172 may be an amount of interactions and/or conversion paths for which interactions related to the domain are earlier than a set of two or more interactions preceding the conversion action that are determined to be “last” interactions for the purposes of determining assist metric 172, last metric 174, and/or analysis metric 170. In various implementations, the set of last interactions may be defined as a predetermined number of interactions prior to a conversion action (e.g., the last two, three, four, etc. interactions prior to conversion), a varying number of interactions based on one or more conditions (e.g., the length of the conversion path), one or more interactions occurring after a particular event (e.g., interactions occurring after a last interaction with a search engine results interface prior to conversion), or in another manner.

Analysis system 150 may determine a last metric 174 for each of the domains based on a second set of conversion paths within path data 162 for which interactions related to the domain are one of the one or more last interactions prior to the conversion actions (215). Last metric 174 may be an absolute or relative amount of interactions and/or conversion paths associated with the domain for which interactions related to the domain are last interactions (e.g., interactions that directly drive the conversions). As discussed above, the interactions defined as “last interactions” for the purpose of determining last metric 174 may differ according to various illustrative implementations.

Analysis system 150 may determine an analysis metric 170 for each domain based on assist metric 172 and last metric 174 (220). Analysis metric 170 may provide an indication of a relative position within the conversion paths of interactions relating to the domain. For instance, if analysis metric 170 is in one particular range (e.g., higher than a threshold), this may indicate that the domain is frequently associated with interactions earlier in the conversion paths than the last interaction(s), such that users interact with the domain early in the interaction process. If analysis metric 170 is an another range (e.g., lower than a threshold), this may indicate that the domain is frequently associated with the last interaction(s), such that the domain tends to directly drive conversions. In some implementations, analysis metric 170 may be or include a ratio of assist metric 172 to last metric 174. In some implementations, analysis metric 170 may include a different combination of assist metric 172 and last metric 174, such as a weighted combination (e.g., weighted sum or product) of assist metric 172 and last metric 174. In some implementations, analysis metric 170 (e.g., an assist-to-last ratio) may be normalized to account for differences in conversion path length.

In some implementations, analysis metric 170 may be or include an assist-to-last ratio for the domain. The assist-to-last ratio may be implemented as a measure of the number of conversion paths that include the domain in relation to assisting interactions versus the number of paths that include the domain in association with a last click before conversion in a path. Thus, in such an implementation, an assist-to-last ratio of one indicates that the domain is associated with assisting interactions and last-click interactions in an equal number of paths. An assist-to-last ratio substantially lower than one indicates that the domain is associated with significantly more conversion paths as a last-click interaction than an assisting interaction, and may indicate that the domain is generally a lower-funnel domain (generally appears lower, or nearer the end conversions, in the conversion paths). An assist-to-last ratio substantially higher than one indicates that the domain appears in significantly more conversion paths as an assisting domain than a last-click domain, and may indicate that the domain is generally a higher-funnel domain (generally appears higher, or further away from the end conversions, in the conversion paths). In some implementations, the assist-to-last ratio may be implemented as a measure of the number of times a domain appears in the conversion path data as an assisting domain versus the number of times the domain in relation to the last click before conversion in the path. In some implementations, the assist-to-last ratio may be implemented as a measure of a total number of conversion paths including the domain in relation to a number of conversion paths where the domain is associated with a last-click interaction. Thus, in such an implementation, an assist-to-last ratio of one indicates that the domain is associated with a last-click interaction in every conversion path.

In some implementations, the assist-to-last ratio may be an assist-click-to-last-click ratio (e.g., a number of assist clicks/selections, or clicks associated with the domain that were not the last click prior to conversion, versus a number of clicks associated with the domain that were the last click prior to conversion). In some implementations, the assist-to-last ratio may be a click-assisted-conversions-to-last-click-conversions ratio (e.g., a number of conversion paths in which the domain was associated with an assist click versus a number of conversion paths in which the domain was associated with the last click before conversion). In some implementations, the assist-to-last ratio may be an assist-impressions-to-last-clicks ratio (e.g., a number of assist impressions, or impressions associated with the domain that were not the last impression shown prior to conversion, versus a number of clicks associated with the domain that were the last click prior to conversion). In some implementations, the assist-to-last ratio may be an impression-assisted-conversions-to-last-click-conversions ratio (e.g., a number of conversion paths in which the domain was associated with an assist impression versus a number of conversion paths in which the domain was associated with the last click before conversion). In various other implementations, other types of conversion contribution metrics (e.g., a first-to-last ratio relating to a number of times the domain appears as a first click versus the number of times it appears as a last click, an average position metric indicating the average position in which the domain appears in the conversion paths, etc.) may be calculated and used in generating recommendations.

In some implementations, system 150 may be configured to determine the interactions and/or conversion paths upon which to determine analysis metric 170 for each domain based on one or more predefined rules 185. In various implementations, rules 185 may include, but are not limited to, a payment basis for one or more paid content placements associated with the interactions related to the domain (e.g., whether the content item was obtained based on a CPC/CPM/CPA/etc. bid) and/or a characteristic of an origin resource associated with the interactions (e.g., whether the content associated with the interaction previous to the interaction associated with the domain was paid content or unpaid referral content, such as an item on a message board or unpaid item displayed within a webpage). System 150 may select conversion paths that meet rules 185 and/or filter out conversion paths that do not meet rules 185 prior to determining analysis metrics 170.

In some implementations, analysis metric 170 may be determined based on conversion path data associated with multiple content providers (e.g., to expand the amount of data upon which the metric is based). FIG. 3 illustrates a flow diagram of one illustrative process for determining analysis metric 170 based on conversion path data for multiple content providers. System 150 may determine a first analysis metric for a domain based on a first set of conversion paths associated with a first content provider (305). The first set of conversion paths may be conversion paths ending in conversions associated with the first content provider (e.g., purchases of items offered for sale by the first content provider). System 150 may determine a second analysis metric for the domain based on a second set of conversion paths associated with a second content provider (310). This process may continue for N content providers, until system 150 has determined an Nth analysis metric for the domain based on an Nth set of conversion paths associated with an Nth content provider (315). System 150 may then determine analysis metric 170 for the domain based on an aggregation (e.g., sum, average/mean, median, etc.) of the first through Nth analysis metrics (320). Any information surfaced to a particular content provider based on analysis metric 170 may reveal only information about the aggregated analysis metric, and not information about the individual underlying analysis metrics for other content providers, to preserve the anonymity and confidentiality of the information relating to the other content providers.

Referring again to FIGS. 1 and 2, in some implementations, system 150 may be configured to group one or more of domains 166 based on one or more characteristics (225). In some implementations, system 150 may group domains 166 based on analysis metrics 170. In one illustrative implementation, system 150 may categorize each domain within groups based on analysis metric ranges associated with the groups. For instance, system 150 may categorize domains having an analysis metric 170 higher than a first threshold as upper-funnel domains that appear more frequently in connection with assisting interactions than last interactions. System 150 may categorize domains having an analysis metric 170 lower than a second threshold as lower-funnel domains that appear more frequently in connection with last interactions than assisting interactions. System 150 may categorize domains having an analysis metric 170 between the first threshold and the second threshold as mid-funnel domains that appear with similar frequency in connections with assisting and last interactions. This is merely one illustrative implementation; in other implementations, system 150 may categorize domains 166 based on analysis metrics 170 in other manners.

In some implementations, system 150 may group domains 166 based on other characteristics. In some implementations, system 150 may group domains 166 at least in part based on an estimated cost of obtaining placements within domains 166. System 150 may be configured to determine a representative (e.g., average) price paid for placements within domains 166 (e.g., based on data received from content management system 108, such as from log files 114). System 150 may categorize domains 166 based in part on the representative price. In one illustrative implementation, system 150 may categorize domains 166 based on both analysis metrics 170 and the representative prices of placements within domains 166. For instance, system 150 may first group domains 166 based on analysis metrics 170, and then may filter and/or further group domains within the groups based on the representative price for obtaining placements within the domains. In some implementations, system 150 may group domains 166 based in part on industry categories or verticals associated with domains 166, such as automotive, consumer electronics, healthcare, etc. In some implementations, system 150 may group domains 166 based on one or more characteristics or dimensions defined by one or more content providers. In one such implementation, system 150 may group domains 166 according to a customer lifetime value (CLV) metric defined by one or more content providers. If enough content providers upload CLV data to provide an adequate sample, the CLV data may be used as selection criteria to categorize domains 166 based on CLV performance. System 150 may be configured to receive confirmation from content providers that they wish to share their defined dimension data with other content providers prior to using the data to categorize domains 166 for other content providers.

System 150 may generate one or more recommendations 180 for obtaining content placements in one or more of domains 166 based on analysis metrics 170 (230). In some implementations, system 150 may recommend one or more domains that system 150 has determined to be upper-funnel domains based on analysis metrics 170. Such domains may appear frequently early in the conversion paths, and may help increase early awareness of a content provider's brand. In some implementations, system 150 may recommend one or more domains that system 150 has determined to be lower-funnel domains that may appear frequently later in the conversion paths. Obtaining placements in such lower-funnel domains may help directly drive additional conversions for the content provider. In some implementations, recommendations 180 may be based on other factors as well, such as an expected cost for placements. In some such implementations, system 150 may recommend obtaining placements in one or more domains based on both analysis metric 170 and an expected cost for placements (e.g., upper-funnel domains with a lowest expected cost to the content provider).

In some implementations, system 150 may generate recommendation(s) 180 based at least in part on a desired strategy reflected in strategy data 190 received from the content provider. In various implementations, the content provider may indicate that it wishes to receive recommendations of placement opportunities similar to its current placements, recommendations of placements in domains that are upper-funnel, and/or recommendations of placements in domains that are lower-funnel. In some implementations, system 150 may select domains to recommend based on whether analysis metrics 170 for the domains reflect that they are likely to meet the desired strategy (e.g., if an assist-to-last ratio is above a threshold when the content provider wishes to receive upper-funnel recommendations and/or below a threshold when the content provider wishes to receive lower-funnel recommendations). In some implementations, system 150 may receive input from the content provider indicating a desired strategy on a progressive scale from conservative to aggressive, where more conservative input may cause system 150 to recommend domains at a position near to or slightly higher in the conversion path funnel than the position of the current placements of the content provider, and more aggressive input may cause system 150 to recommend domains at a position substantially higher in the conversion path funnel than the current placements.

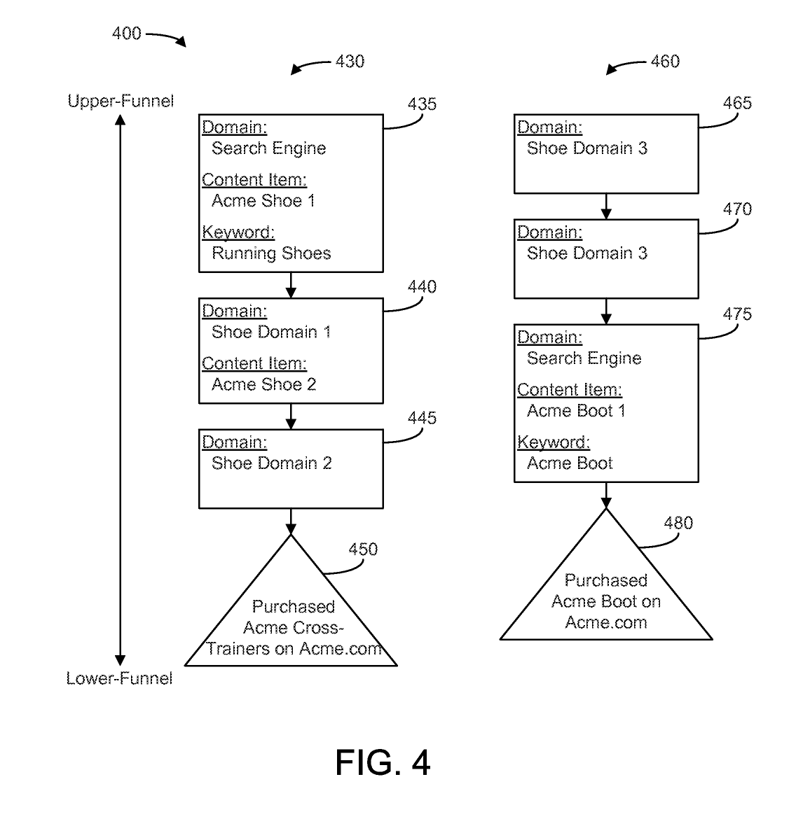

Referring now to FIG. 4, a visual representation of conversion path data 400 is shown according to an illustrative implementation. Conversion path data 400 includes a first conversion path 430 including several interactions. In a first interaction 435, the user enters the query “Running Shoes” in a search engine search interface, and is presented with a paid content item “Acme Shoe 1” within a results interface. The user clicks the “Acme Shoe 1” item, and is directed to a webpage within a domain “Shoe Domain 1” (e.g., www.shoedomain1.com) (second interaction 440). Another content item, “Acme Shoe 2,” is displayed within the webpage, and the user clicks this item and is directed to another interaction 445 with a webpage in a domain “Shoe Domain 2.” Interaction 445 leads to a purchase of an “Acme Cross-Trainers” product on the Acme Shoe Company website (converting action 450).

Another conversion path 460 includes a first interaction 465 in which the user navigates to a webpage within a domain “Shoe Domain 3.” The user again interacts with a webpage in “Shoe Domain 3” (e.g., the same page or a different page) in a second interaction 470. Subsequent to interaction 470, the user navigates to a search engine search interface and submits the query “Acme Boot,” in response to which the user is presented with a content item “Acme Boot 1” within a results interface of the search engine (interaction 475). The user clicks through the content item, navigating to the Acme Shoe Company website, and purchases an “Acme Boot” product (converting action 480).

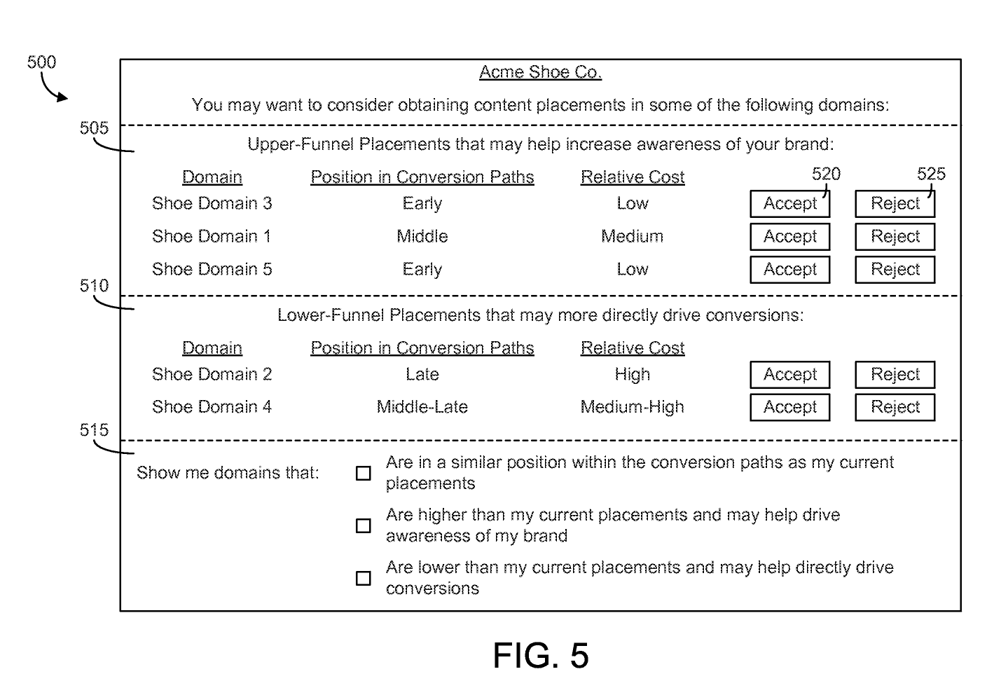

Referring now to FIG. 5, an illustration of a user interface 500 configured to provide content placement recommendations such as those generated using process 200 of FIG. 2 is shown according to an illustrative implementation. Interface 500 includes recommendations that may be based in part on conversion path data 400 shown in FIG. 4.

Interface 500 includes an upper-funnel recommendation portion 505 in which one or more recommendations for upper-funnel domains are provided. In the illustrated implementation, system 150 has recommended that the content provider consider obtaining content placements in the domains Shoe Domain 3, Shoe Domain 1, and Shoe Domain 5, as such placements may help drive early brand awareness. In some implementations, interface 500 may indicate a relative position within the conversion paths of each of the recommended domains and/or a relative expected cost for obtaining placements within the domains. Interface 500 also includes a lower-funnel recommendation portion 510 in which one or more recommendations for lower-funnel domains are provided. In the illustrated implementation, system 150 has recommended that the content provider consider placements in Shoe Domains 2 and 4, as these placements may help directly drive additional conversions. The content provider may accept or reject the recommendations by clicking buttons 520 and 525, respectively. In some implementations, when the content provider clicks an accept button 520, system 150 may implement the selected recommendation, such as by generating a bid for content placements within the domain (e.g., by transmitting a message to establish the bid to content management system 108). In some implementations, system 150 may revise future recommendations based on whether recommendations are accepted and rejected. For instance, system 150 may increase and/or decrease a likelihood that similar domains will be recommended in the future (e.g., via a weighting value applied to the recommendations) based on whether a recommendation is accepted or rejected.

In some implementations, interface 500 may include a strategy portion 515 through which a content provider may provide input regarding a desired strategy to be applied in generating recommendations. In the illustrated implementation, interface 500 allows the content provider to indicate whether system 150 should provide recommendations for domains at a similar position within the conversion paths as the content provider's current placements, at a higher position than its current placements, and/or at a lower position than its current placements. In various other implementations, other types of strategy information may be provided by the content provider through strategy portion 515.

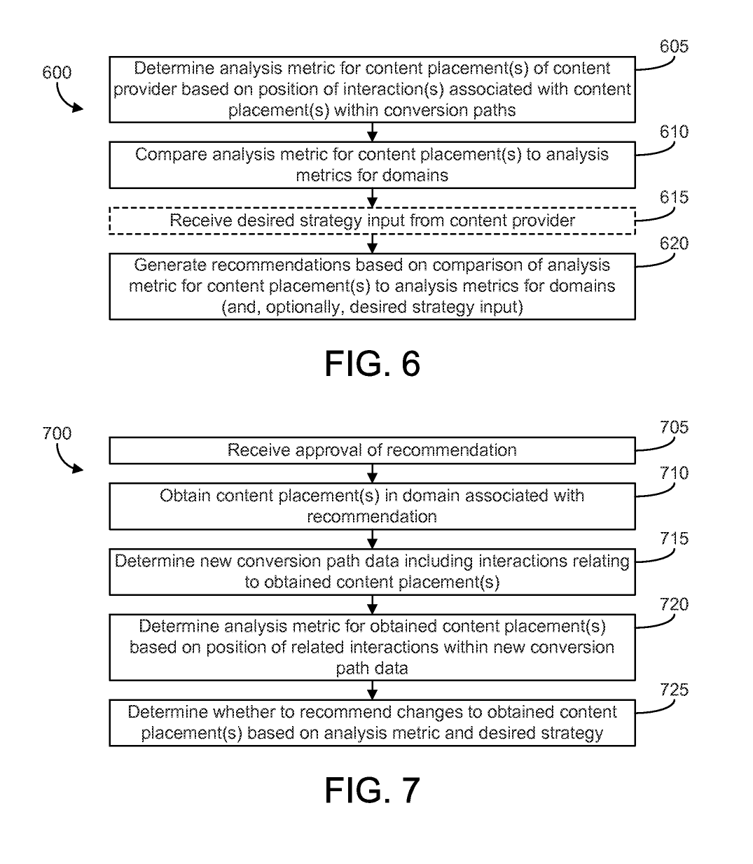

In some implementations, system 150 may be configured to generate recommendations 180 based in part on a relative position of current content placements 168 of a content provider within the conversion paths. FIG. 6 illustrates a flow diagram of a process 600 for generating recommendations 180 based on current content placements 168 of a content provider according to an illustrative implementation. Referring now to FIGS. 1 and 6, system 150 may determine an analysis metric (e.g., an assist-to-last ratio) for content placements 168 based on a relative position of interactions 164 associated with content placements 168 within the conversion paths reflected in path data 162 (605). The analysis metric for the interactions associated with content placements 168 may be determined in a similar manner to those for domains 166.

System 150 may compare the determined analysis metric for content placements 168 to analysis metrics 170 for domains 166 (610). In some implementations, system 150 may determine domains that are in a similar position within the conversion paths as content placements 168, such as by identifying domains having an analysis metric within a threshold difference from the analysis metric of content placements 168. In some implementations, system 150 may determine domains that are more upper-funnel than content placements 168 (e.g., domains having an analysis metric that is outside of the threshold difference from the metric of content placements 168 and indicates that the domains are upper-funnel domains) and/or domains that are more lower-funnel than content placements 168 (e.g., domains having an analysis metric that is outside of the threshold difference from the metric of content placements 168 and indicates that the domains are lower-funnel domains).

In some implementations, system 150 may receive input from the content provider regarding a desired strategy with respect to current content placements 168 (615). In some such implementations, strategy data 190 received from the content provider may indicate that the content provider is interested in receiving recommendations for placements in domains that are at a similar position within the conversion paths as its current content placements 168. In some such implementations, strategy data 190 may indicate that the content provider is interested in receiving recommendations for placements in domains that are more upper-funnel than its current content placements 168.

System 150 may generate recommendations 180 based on the comparison of the analysis metric for current content placements 168 to analysis metrics 170 for domains 166 (620). In various implementations, recommendations 180 may recommend obtaining placements in upper-funnel domains, lower-funnel domains, mid-funnel domains, and/or domains at a similar position within the conversion paths as current content placements 168. In some implementations, system 150 may generate recommendations 180 based in part on strategy data 190 indicating a desired strategy of the content provider. In one such implementation, strategy data 190 may indicate that the content provider wishes to receive recommendations for placements at a similar position as its current placements, and system 150 may generate and provide recommendations having analysis metrics that are similar in value to the analysis metric of the current placements of the content provider.

In some implementations, system 150 may be configured to implement approved recommendations and monitor newly obtained placements to determine whether they meet the desired strategy of the content provider. FIG. 7 is a flow diagram of a process 700 for determining whether to recommend changes to obtained content placements according to an illustrative implementation. In some implementations, process 700 may be executed subsequent to a content provider approving a recommendation generating in operation 620 of process 600.

Referring now to FIGS. 1 and 7, system 150 may receive approval of a recommendation from a content provider (705) and may obtain one or more content placements in a domain associated with the recommendation (710). System 150 may determine new conversion path data including one or more interactions relating to the obtained content placements (715). System 150 may determine an analysis metric for the obtained content placements based on a position of the related interactions within the new conversion path data (720). In some implementations, system 150 may be configured to calculate an assist-to-last ratio for the newly obtained content placements.

System 150 may determine whether to recommend changes to the obtained content placements based on the determined analysis metric and the desired strategy of the content provider (725). For instance, if the content provider indicated that it wishes to obtain upper-funnel placements that may drive early awareness of its brands, and the analysis metric of the obtained content placements indicates that the interactions related to the placements are lower-funnel interactions that are close to the conversions within the paths, system 150 may recommend that the content provider reduce its bids on the placements or no longer bid on the placements moving forward. In another implementation, if the content provider indicated that it wishes to obtain upper-funnel placements, and the analysis metric of the obtained content placements indicates that the interactions related to the placements are upper-funnel interactions within the new conversion paths, system 150 may determine that the newly obtained placements meet the content provider's desired strategy, and may recommend that the content provider consider increasing its bids to obtain additional placements. In this manner, system 150 may test the recommendations after implementation and may help optimize the obtained placements to meet the goals of the content provider.

In some implementations, system 150 may utilize analysis metrics 170 to determine one or more domains 166 in which to obtain placements for offer by a content network. A content network may offer content placements across multiple domains (e.g., embedded within resources of the domains, such as webpages), such as through bidding processes. Operators of content networks may desire to identify content placements to add to the content networks. In some implementations, system 150 may identify potential domains for new content placements, and may determine whether to invite the domain providers of the domains to add one or more placements within the domains to the content network based on the analysis metrics of the domains. For instance, system 150 may identify one or more domains having an assist-to-last ratio above a threshold, indicating that the placements associated with the domains are upper-funnel placements. System 150 may recommend that an operator of the content network consider inviting the domain providers of the domains to add the domain to the content network, and/or may automatically transmit invitations to the domain providers to join the content network. In some implementations, system 150 may determine whether to recommend invitations for domains based on one or more additional factors, such as an expected cost of the placements, a desired price received from the domain provider, etc.

In some implementations, system 150 may utilize analysis metrics 170 to compare placements offered by multiple content networks. In some such implementations, system 150 may determine a first analysis metric for content placements offered by a first content network, and may determine a second analysis metric for content placements offered by a second (e.g., competitor) content network. The placements offered by the first content network may be in a first set of one or more domains, and the first analysis metric may be determined based on the analysis metrics of the domains within the first set of domains (e.g., based on a combination, such as an average, of the analysis metrics of the domains associated with the first content network). The placements offered by the second content network may be in a second set of one or more domains, and the second analysis metric may be determined based on the analysis metrics of the second set of one or more domains. System 150 may compare the analysis metrics, and may provide an indication of the relative position of the interactions associated with the content placements for the two networks based on the comparison. For instance, if an assist-to-last ratio for a first content network is significantly higher than an assist-to-last ratio for a second network, system 150 may determine that the placements of the first network are more upper-funnel than those of the second network. In some implementations, this information may be provided to a representative of the first or second content network for use in marketing to potential customers of the content network, and/or may be provided to the end-customers for use in selecting a content network.

In some circumstances, path data 162 may include paths that appear to end prior to a conversion, but which are actually continued in other paths. In some implementations, analysis system 150 may be configured to determine whether any non-converting paths in path data 162 are actually continued in other user paths, and are not in fact non-converting paths. In some instances, some user paths may be incorrectly interpreted as non-converting paths ending in abandonment events. In some implementations, a user may complete one or more interactions on a first device, such as a mobile device, then move to a second device (e.g., a desktop or laptop computer) to complete additional interactions, the last of which may be a conversion action (e.g., a product purchase). In such implementations, path data 162 may not connect the interactions on the first device with those on the second device, and system 150 may improperly interpret the last interaction on the first device as an abandonment.

In some implementations, system 150 may be configured to detect false positive abandonment events within path data 162 and connect the related paths to form more accurate, complete conversion paths for use in generating analysis metrics 170. System 150 may determine one or more false positive abandonment events within path data 162. In some implementations, system 150 may utilize an identifier or other signal associated with a path indicating that the user interactions associated with the path are continued on another path associated with another device. Based on the data, system 150 may determine whether a path that appears to be a non-converting path includes a false positive abandonment event, such that the user interactions were continued as reflected in another path associated with another device. System 150 may then merge the two partial paths to determine the full conversion path prior to determining analysis metrics 170 based on the path.

In some implementations, system 150 may be configured to allow a content provider to experiment with different content items in different stages of user conversion paths and determine the impact on analysis metric 170. System 150 may determine different analysis metrics associated with different sets of conversion paths exhibiting different conditions of a characteristic, such as conversion paths in which different types of content items are displayed to users in response to the same search query. In one illustrative implementation, system 150 may capture conversion path data corresponding to different conversion paths for a domain associated with a travel content provider. In one set of conversion paths, a map of Tuscany with regional highlights may have been presented in response to a query “hotel Tuscany” being entered into a search engine interface. In another set of conversion paths, a list of the main cities in Tuscany may be shown, and in another set of conversion paths, a booking engine for hotels offered by the travel content provider may be shown. System 150 may calculate separate analysis metrics for the different sets of conversion path data. The resulting analysis metrics may be compared to illustrate the impact of the different items to the content provider.

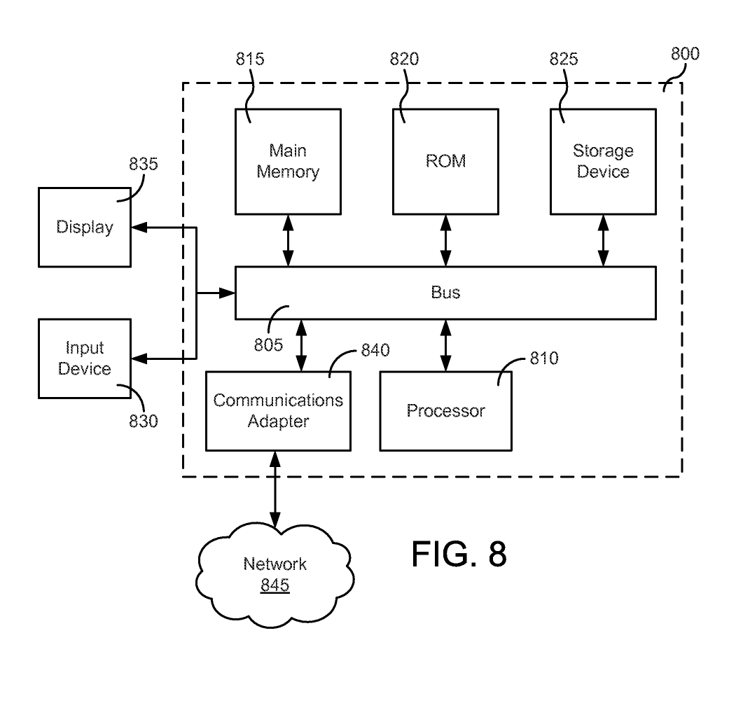

FIG. 8 illustrates a depiction of a computer system 800 that can be used, for example, to implement an illustrative user device 104, an illustrative content management system 108, an illustrative content provider device 106, an illustrative analysis system 150, and/or various other illustrative systems described in the present disclosure. The computing system 800 includes a bus 805 or other communication component for communicating information and a processor 810 coupled to the bus 805 for processing information. The computing system 800 also includes main memory 815, such as a random access memory (RAM) or other dynamic storage device, coupled to the bus 805 for storing information, and instructions to be executed by the processor 810. Main memory 815 can also be used for storing position information, temporary variables, or other intermediate information during execution of instructions by the processor 810. The computing system 800 may further include a read only memory (ROM) 810 or other static storage device coupled to the bus 805 for storing static information and instructions for the processor 810. A storage device 825, such as a solid state device, magnetic disk or optical disk, is coupled to the bus 805 for persistently storing information and instructions.

The computing system 800 may be coupled via the bus 805 to a display 835, such as a liquid crystal display, or active matrix display, for displaying information to a user. An input device 830, such as a keyboard including alphanumeric and other keys, may be coupled to the bus 805 for communicating information, and command selections to the processor 810. In another implementation, the input device 830 has a touch screen display 835. The input device 830 can include a cursor control, such as a mouse, a trackball, or cursor direction keys, for communicating direction information and command selections to the processor 810 and for controlling cursor movement on the display 835.

In some implementations, the computing system 800 may include a communications adapter 840, such as a networking adapter. Communications adapter 840 may be coupled to bus 805 and may be configured to enable communications with a computing or communications network 845 and/or other computing systems. In various illustrative implementations, any type of networking configuration may be achieved using communications adapter 840, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. In alternative implementations, hard-wired circuitry may be used in place of or in combination with software instructions to implement illustrative implementations. Thus, implementations are not limited to any specific combination of hardware circuitry and software.

Although an example processing system has been described in FIG. 8, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer-readable storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
determining, at a computerized analysis system, conversion path data comprising data relating to a plurality of conversion paths, each of the plurality of conversion paths comprising one or more interactions leading to a respective one of a plurality of conversion actions, one or more of the plurality of interactions relating to a plurality of domains;
determining, at the analysis system, for each of the plurality of domains:
a first metric based on a first set of the plurality of conversion paths for which interactions related to the domain are earlier in the conversion paths than one or more last interactions prior to the conversion actions of the conversion paths;
a second metric based on a second set of the plurality of conversion paths for which interactions related to the domain are one of the one or more last interactions prior to the conversion actions of the conversion paths; and
an analysis metric based on the first metric and the second metric indicating a relative position within the plurality of conversion paths of the interactions relating to the domain; and
generating one or more recommendations for obtaining content placements in one or more of the domains based on the analysis metrics for the plurality of domains.

2. The method of claim 1, wherein the analysis metric comprises an assist-to-last ratio, wherein the assist-to-last ratio comprises a measure of a first number of times an interaction associated with the domain is earlier in a conversion path than the one or more last interactions prior to one of the plurality of conversion actions versus a second number of times an interaction associated with the domain is one of the one or more last interactions prior to one of the plurality of conversion actions.

3. The method of claim 1, wherein determining the analysis metric for each of the plurality of domains comprises:
determining a first analysis metric for the domain based on a first set of the plurality of conversion paths associated with a first content provider;
determining a second analysis metric for the domain based on a second set of the plurality of conversion paths associated with a second content provider; and
determining the analysis metric for the domain based on an aggregation of the first analysis metric and the second analysis metric.

4. The method of claim 3, wherein determining the analysis metric for each of the plurality of domains further comprises, for at least one of the domains, determining the interactions based upon which the analysis metric is determined using one or more predefined rules.

5. The method of claim 4, wherein the one or more predefined rules comprise at least one of a payment basis of one or more paid content placements associated with the interactions or a characteristic of an origin resource associated with the interactions.

6. The method of claim 1, further comprising grouping one or more of the plurality of domains based on one or more characteristics, the one or more recommendations being generated based in part on the groupings of the domains.

7. The method of claim 6, wherein the one or more characteristics comprise at least one of an industry category of the domains or a predicted cost of obtaining the content placements in the domains.

8. The method of claim 6, wherein the one or more characteristics comprise at least one characteristic defined by a content provider.

9. The method of claim 1, wherein generating the one or more recommendations comprises:
determining a first analysis metric for one or more content placements of a content provider based on a position of one or more interactions associated with the one or more content placements within the plurality of conversion paths;
comparing the first analysis metric to the analysis metrics for the plurality of domains; and
generating the one or more recommendations for the content provider based on the comparison of the first analysis metric to the analysis metrics for the plurality of domains.

10. The method of claim 9, further comprising receiving input from the content provider representing a desired strategy for generating the one or more recommendations, the desired strategy relating to a desired relative position of the interactions to which the domain relates within the plurality of conversion paths with respect to the position of the interactions associated with the one or more content placements of the content provider, wherein the one or more recommendations are generated based in part on the input from the content provider representing the desired strategy.

11. The method of claim 10, wherein generating the one or more recommendations comprises generating a first recommendation based in part on the desired strategy from the content provider, and wherein the method further comprises:
receiving approval of the first recommendation from the content provider;
obtaining one or more content placements in a first domain associated with the first recommendation;
determining new conversion path data comprising one or more conversion paths including interactions relating to the obtained one or more content placements in the first domain; and
determining an analysis metric for the obtained one or more content placements based on a position of the interactions relating to the obtained one or more content placements within the conversion paths.

12. The method of claim 11, further comprising determining whether to recommend changes to the obtained one or more content placements based on the analysis metric for the obtained one or more content placements and the desired strategy from the content provider.

13. The method of claim 11, further comprising modifying at least one parameter used in determining one or more subsequent recommendations for at least one of the content provider or one or more additional content providers based on the analysis metric for the obtained one or more content placements.

14. The method of claim 1, further comprising determining whether to invite one or more domain providers of one or more of the domains to add the one or more domains to a content network offering content placements across domains based on the analysis metrics of the one or more domains.

15. The method of claim 1, further comprising:
determining a first analysis metric associated with a content network, the content network offering content placements in a first set of one or more domains within the plurality of domains, the first analysis metric being determined based on the analysis metrics of the domains within the first set of one or more domains;
determining a second analysis metric associated with a competitor content network offering content placements in a second set of one or more domains within the plurality of domains, the second analysis metric being determined based on the analysis metrics of the domains within the second set of one or more domains; and
providing an indication of the relative position of interactions associated with the content placements offered by the content network and the competitor content network based on a comparison of the first analysis metric and the second analysis metric.

16. The method of claim 1, further comprising, for at least one domain of the plurality of domains:
determining a first analysis metric for a first subset of conversion paths associated with the at least one domain, the first subset of conversion paths having a first condition of a characteristic;
determining a second analysis metric for a second subset of conversion paths associated with the at least one domain, the second subset of conversion paths having a second condition of a characteristic; and
providing a comparison of the first condition and the second condition based on a comparison of the first analysis metric and the second analysis metric.

17. A system comprising:
at least one computing device operably coupled to at least one memory and configured to:
determine conversion path data comprising data relating to a plurality of conversion paths, each of the plurality of conversion paths comprising one or more interactions leading to a respective one of a plurality of conversion actions, one or more of the plurality of interactions relating to a plurality of domains;
determine, for each of the plurality of domains:
a first metric based on a first set of the plurality of conversion paths for which interactions related to the domain are earlier in the conversion paths than one or more last interactions prior to the conversion actions of the conversion paths;
a second metric based on a second set of the plurality of conversion paths for which interactions related to the domain are one of the one or more last interactions prior to the conversion actions of the conversion paths; and
an analysis metric based on the first metric and the second metric indicating a relative position within the plurality of conversion paths of the interactions relating to the domain; and
generate one or more recommendations for obtaining content placements in one or more of the domains based on the analysis metrics for the plurality of domains.

18. The system of claim 17, wherein the analysis metric comprises an assist-to-last ratio, wherein the assist-to-last ratio comprises a measure of a first number of times an interaction associated with the domain is earlier in a conversion path than the one or more last interactions prior to one of the plurality of conversion actions versus a second number of times an interaction associated with the domain is one of the one or more last interactions prior to one of the plurality of conversion actions.

19. The system of claim 17, wherein the at least one computing device is configured to group one or more of the plurality of domains based on one or more characteristics and generate the one or more recommendations based in part on the groupings of the domains.

20. The system of claim 17, wherein the at least one computing device is configured to generate the one or more recommendations by:
determining a first analysis metric for one or more content placements of a content provider based on a position of one or more interactions associated with the one or more content placements within the plurality of conversion paths;
comparing the first analysis metric to the analysis metrics for the plurality of domains; and
generating the one or more recommendations for the content provider based on the comparison of the first analysis metric to the analysis metrics for the plurality of domains.

21. The system of claim 17, wherein the at least one computing device is configured to:
receive input from the content provider representing a desired strategy for generating the one or more recommendations, the desired strategy relating to a desired relative position of the interactions to which the domain relates within the plurality of conversion paths with respect to the position of the interactions associated with the one or more content placements of the content provider; and
generate the one or more recommendations based in part on the input from the content provider representing the desired strategy.

22. The system of claim 21, wherein the at least one computing device is further configured to:
generate a first recommendation based in part on the desired strategy from the content provider;
receive approval of the first recommendation from the content provider;
obtain one or more content placements in a first domain associated with the first recommendation;
determine new conversion path data comprising one or more conversion paths including interactions relating to the obtained one or more content placements in the first domain;
determine an analysis metric for the obtained one or more content placements based on a position of the interactions relating to the obtained one or more content placements within the conversion paths; and
determine whether to recommend changes to the obtained one or more content placements based on the analysis metric for the obtained one or more content placements and the desired strategy from the content provider.

23. One or more computer-readable storage media having instructions stored thereon that, when executed by at least one processor, cause the at least one processor to perform operations comprising:
determining conversion path data comprising data relating to a plurality of conversion paths, each of the plurality of conversion paths comprising one or more interactions leading to a respective one of a plurality of conversion actions, one or more of the plurality of interactions relating to a plurality of domains;
determining, for each of the plurality of domains:
a first metric based on a first set of the plurality of conversion paths for which interactions related to the domain are earlier in the conversion paths than one or more last interactions prior to the conversion actions of the conversion paths;
a second metric based on a second set of the plurality of conversion paths for which interactions related to the domain are one of the one or more last interactions prior to the conversion actions of the conversion paths; and
an analysis metric based on the first metric and the second metric indicating a relative position within the plurality of conversion paths of the interactions relating to the domain;
receiving input from a content provider representing a desired strategy for generating one or more recommendations, the desired strategy relating to a desired position of the interactions to which the domain relates within the plurality of conversion paths; and
generating the one or more recommendations for obtaining content placements in one or more of the domains based on the analysis metrics for the plurality of domains and the input representing the desired strategy.

24. The one or more computer-readable storage media of claim 23, wherein generating the one or more recommendations comprises:
determining a first analysis metric for one or more content placements of a content provider based on a position of one or more interactions associated with the one or more content placements within the plurality of conversion paths;
comparing the first analysis metric to the analysis metrics for the plurality of domains; and
generating the one or more recommendations for the content provider based on the comparison of the first analysis metric to the analysis metrics for the plurality of domains.
